(19) United States
(12) Patent Application Publication
(10) Pub. No.: US 2026/0359159 A1
(43) Pub. Date: Nov. 12, 2026

(54) DYNAMIC STRATEGY FRAMEWORK AND END-TO-END DIGITAL THREAD ORCHESTRATOR FOR ENTERPRISE DIGITAL TRANSFORMATIONS

(71) Applicant: The Boeing Company, Arlington, VA (US)

(72) Inventors: Guijun WANG, Issaquah, WA (US); Ahmad Reza YAGHOOBI, Issaquah, WA (US)

(21) Appl. No.: 19/200,327

(22) Filed: May 6, 2025

(51) Int. Cl. G06F 11/07

(52) U.S. Cl. CPC G06F 11/079; G06F 11/0721; G06F 11/0754

(57) ABSTRACT

Various aspects of the present disclosure generally relate to a device. In some implementations, the device may receive information identifying a strategy framework for an enterprise entity. The device may generate a characterization of the strategy framework. The device may evaluate the strategy framework. The device may generate a set of recommendations of a set of strategy framework modification actions. The device may execute an algorithm corresponding to the set of recommendations. The device may generate a complexity measurement. The device may generate an allocation strategy relating to an identified issue. The device may generate a digital transformation implementation strategy. The device may transmit a set of outputs associated with identifying the digital transformation implementation strategy. Numerous other aspects are described.

### FIELD

The present disclosure relates generally to digital transformations and to a dynamic strategy framework and end-to-end digital thread orchestrator for enterprise digital transformations.

### BACKGROUND

Digital transformation integrates advanced technologies into systems, optimizing performance, scalability, and interoperability. Entities replace legacy architectures with cloud computing, microservices, and containerization to enhance flexibility and reduce latency. Artificial intelligence (AI) and machine learning automate data processing, improving predictive analytics and decision-making. Internet of Things (IoT) devices and edge computing decentralize data handling, minimizing bottlenecks and increase real-time responsiveness. A digital thread connects data across the entire lifecycle of a product or system, ensuring seamless integration between design, manufacturing, and operational phases. Cybersecurity measures, including zero-trust frameworks and encryption, mitigate risks in interconnected environments. Software-defined networking (SDN) and 5G (and beyond) enable higher bandwidth and lower latency for distributed applications. This process continuously evolves as emerging technologies refine computational efficiency and system intelligence.

### SUMMARY

An embodiment of the present disclosure provides a method, comprising: receiving, by a device, information identifying a strategy framework for an enterprise entity, wherein the strategy framework includes a set of information transformations; generating, by the device and using a strategy framework model, a characterization of the strategy framework; evaluating, by the device, the characterization of the strategy framework with respect to a plurality of evaluation criteria and a set of algorithms associated with complexity measurement computation; generating, by the device and based on the plurality of evaluation criteria and the complexity measurement computation, a set of recommendations of a set of strategy framework modification actions; executing, by the device and to implement a recommendation of the set of recommendations, an algorithm corresponding to the recommendation; generating, based on executing the algorithm, a complexity measurement, wherein the complexity measurement is a multi-dimensional measurement relating to the strategy framework; generating, by the device and based on the complexity measurement, an allocation strategy relating to an identified issue, wherein the allocation strategy includes an identification of a system to remediate the identified issue, wherein the system is a new system or a supplementary system; generating, by the device and based on the allocation strategy, a digital transformation implementation strategy; and transmitting, by the device, a set of outputs associated with identifying the digital transformation implementation strategy or one or more determinations from which the digital transformation implementation strategy is generated.

Another embodiment of the present disclosure provides a device, comprising: one or more memories; and one or more processors, coupled to the one or more memories, configured to: receive information identifying a strategy framework for an enterprise entity, wherein the strategy framework includes a set of information transformations; generate, using a strategy framework model, a characterization of the strategy framework; evaluate the characterization of the strategy framework with respect to a plurality of evaluation criteria; generate, by the device and based on the plurality of evaluation criteria, a set of recommendations of a set of strategy framework modification actions; execute, to implement a recommendation of the set of recommendations, an algorithm corresponding to the recommendation; generate, based on executing the algorithm, a complexity measurement, wherein the complexity measurement is a multi-dimensional measurement relating to the strategy framework; generate a resource allocation based on the complexity measurement; and transmit a set of outputs identifying the resource allocation associated with the complexity measurement.

Yet a further embodiment of the present disclosure provides a non-transitory computer-readable medium storing a set of instructions, the set of instructions comprising: one or more instructions that, when executed by one or more processors of a device, cause the device to: receive information identifying a strategy framework for an enterprise entity, wherein the strategy framework includes a set of information transformations; generate, using a strategy framework model, a characterization of the strategy framework; evaluate the characterization of the strategy framework with respect to a plurality of evaluation criteria; generate, by the device and based on the plurality of evaluation criteria, a set of recommendations of a set of strategy framework modification actions; execute, to implement a recommendation of the set of recommendations, an algorithm corresponding to the recommendation; generate, based on executing the algorithm, a complexity measurement, wherein the complexity measurement is a multi-dimensional measurement relating to the strategy framework; transmit a set of outputs identifying a digital transformation implementation strategy associated with the complexity measurement; receive information identifying a progress associated with a transformation of a component associated with the digital transformation implementation strategy from a resource associated with the digital transformation implementation strategy; and update a tracking system data structure with the information identifying the progress.

The features, functions, and advantages described herein can be achieved independently in various implementations or can be combined in other implementations, further details of which are shown in the drawings and described below.

### BRIEF DESCRIPTION OF THE DRAWINGS

FIGS. 1A-1F are diagrams of an example associated with a dynamic strategy framework and end-to-end digital thread orchestrator for enterprise digital transformations.

FIG. 2 is a diagram of an example environment in which systems and/or methods described herein may be implemented.

FIG. 3 is a diagram of example components of a device associated with a dynamic strategy framework and an end-to-end digital thread orchestrator for enterprise digital transformations.

FIGS. 4-6 are flowcharts of an example process associated with a dynamic strategy framework.

### DETAILED DESCRIPTION

The following detailed description of example implementations refers to the accompanying drawings. The same reference numbers in different drawings identify the same or similar elements.

Digital thread technology is the linking of digital information relating to a real-world process, to a product, to information or data, or to a system for end-to-end product lifecycle management. A digital thread may be associated with a maturity level, such as a high maturity digital thread or a low maturity digital thread. The maturity level may relate to an extent to which a digital thread is developed, integrated, or effective. In other words, the maturity level may relate to whether a process, product, information or data, or a system is accurately represented via digital information for end-to-end lifecycle management. For example, a high maturity digital thread may exhibit data integration, lifecycle coverage, traceability, automation, standardization, and real-time tracking. In other words, for a high maturity digital thread, data flows seamless across an entire lifecycle, providing real-time insights, artificial intelligence (AI) based predictions, and decision and product traceability, whereas a low maturity digital thread may have siloed data, independent systems, lack automation, or lack traceability, among other examples. Digital transformation is a process by which digital threads may be analyzed and converted from low maturity digital threads to high maturity digital threads.

By converting a low maturity digital thread to a high maturity digital thread, an entity may achieve process continuity, improved efficiency, information traceability, or system automation, among other examples. In this case, the entity may reduce resource utilization or improve an efficiency of resource allocations. Accordingly, it is desirable to provide an automated framework for digital transformation, thereby solving the technical problems of siloed data, independent systems, non-automated processes, non-traceable products or decisions, poor resource allocation efficiency, or excess resource utilization. Such a technical problem may be particularly acute in enterprise contexts, in which entities may have hundreds of systems receiving data from millions of data sources (e.g., computers or Internet of Things (IoT) devices) for controlling complex manufacturing tasks, repair tasks, logistics tasks, or other types of tasks.

Some implementations described herein provide a digital strategy framework and end-to-end digital thread orchestrator for enterprise digital transformations. For example, a device, such as an analysis system, may assess and measure a current state of a digital thread, generate a set of transformation targets and complexity measurements relating to the transformation targets, rationalize a set of transformation actions or strategies, or automatically generate a set of outputs. In this way, the analysis system may orchestrate a digital transformation for a digital thread with a coherent set of methods and frameworks, thereby improving a speed of digital thread transformations and/or a result of the digital thread transformations. For example, the analysis system may reduce a resource utilization or an amount of time to transform a digital thread from a low maturity digital thread to a high maturity digital thread, thereby improving resource utilization associated with digital thread transformation. Additionally, or alternatively, the analysis system may enable the digital thread to be transformed to higher maturity levels than can be achieved using ad-hoc, ill-defined, manual procedures, thereby solving the aforementioned technical problems associated with having low maturity digital threads.

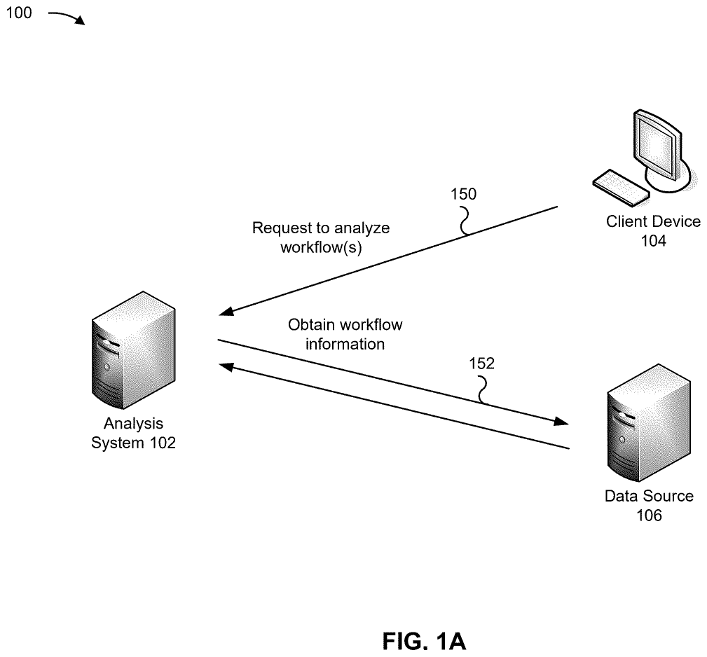

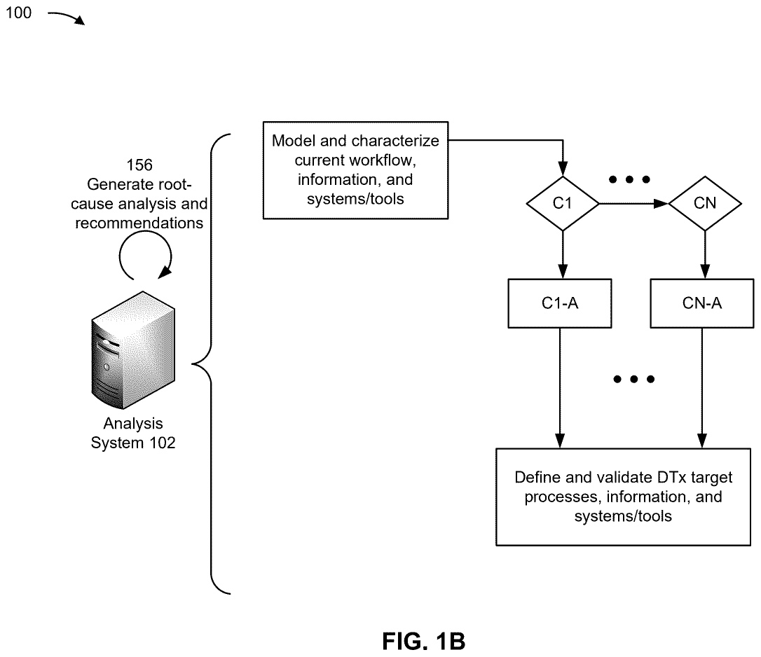

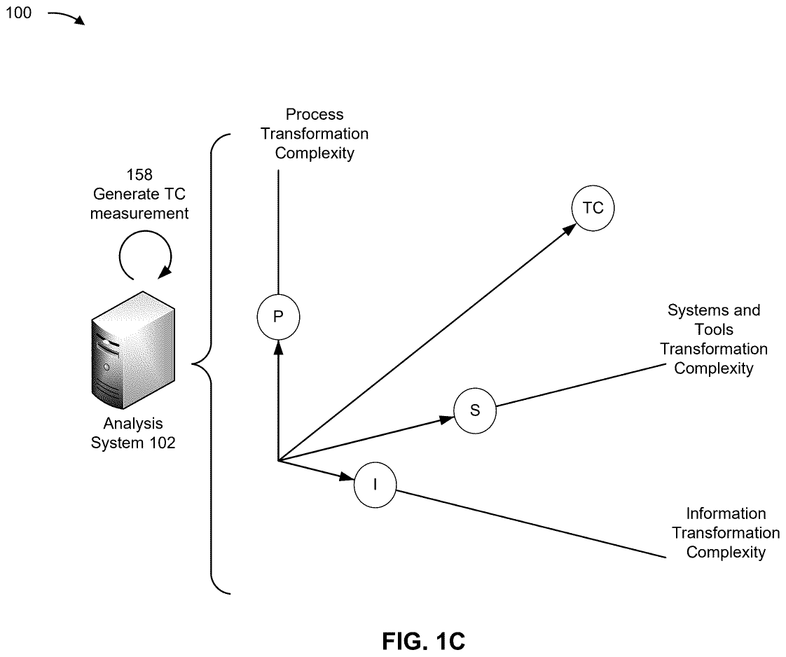

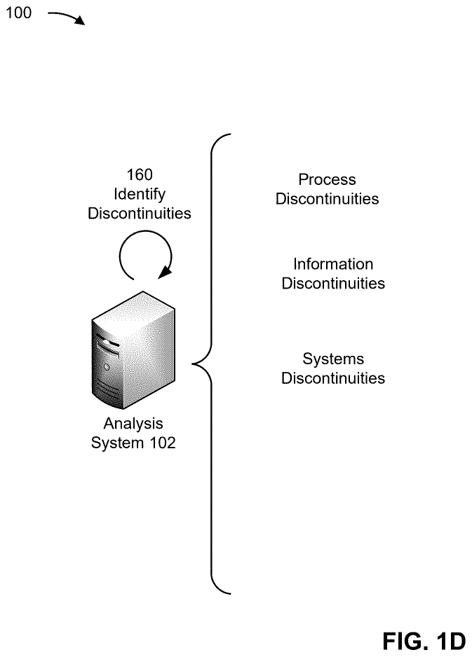

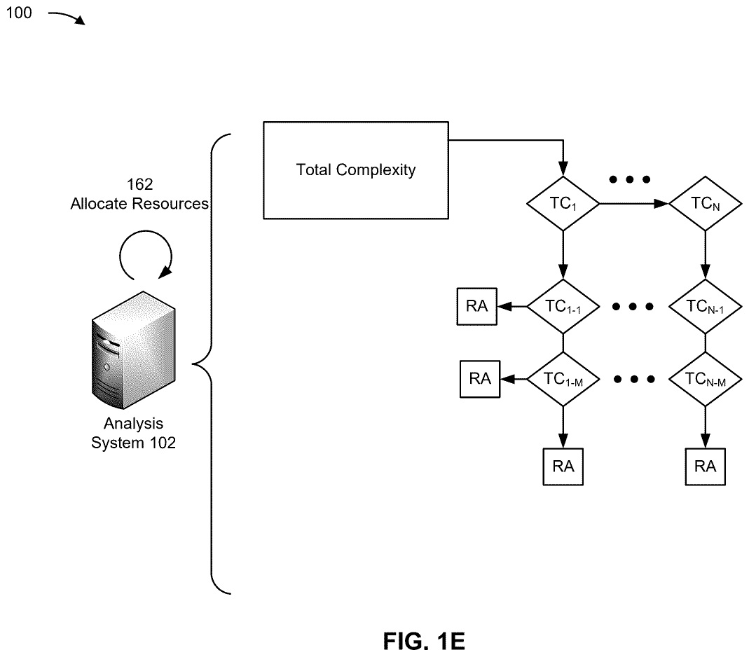

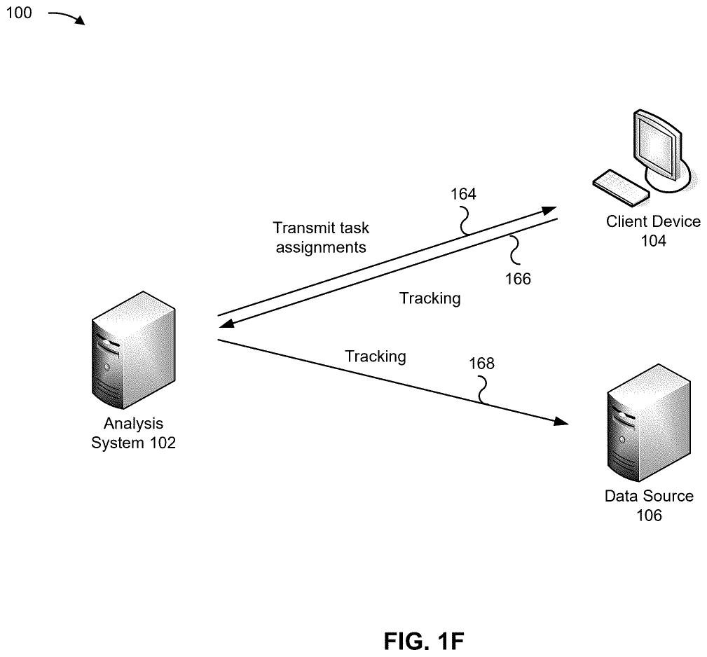

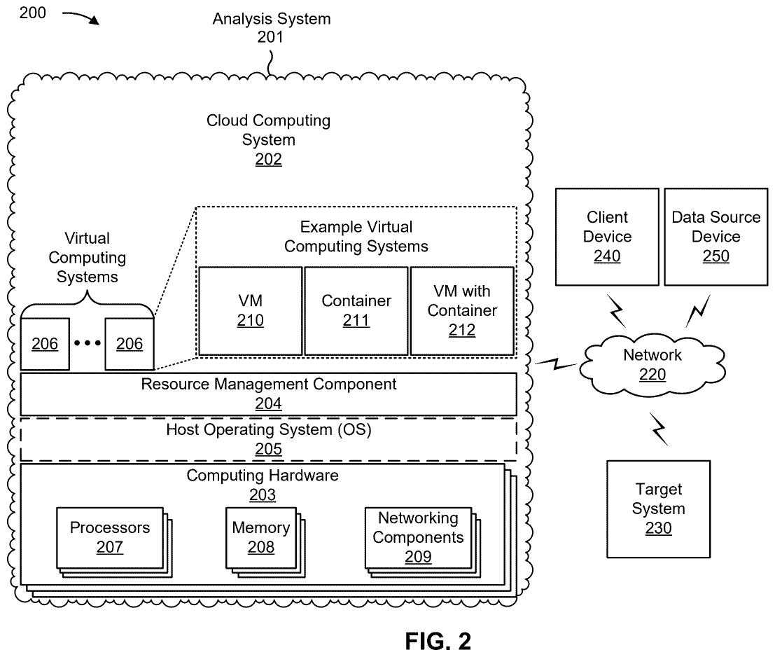

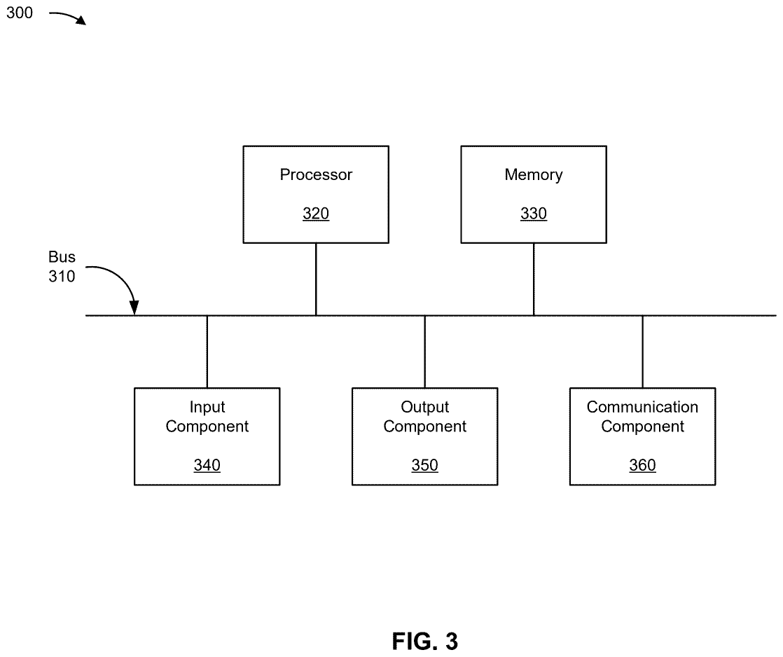

FIGS. 1A-1F are diagrams of an example 100 associated with a dynamic strategy framework and end-to-end digital thread orchestrator for enterprise digital transformations. As shown in FIGS. 1A-1F, example 100 includes an analysis system 102, a client device 104, and a data source 106. These devices are described in more detail in connection with FIGS. 2 and 3.

As further shown in FIG. 1A, and by reference number 150, the analysis system 102 receives a request to analyze one or more workflows. For example, the analysis system 102 may receive, from the client device 104, information identifying a strategy framework for an enterprise entity. In some implementations, the analysis system 102 receives the request to generate a digital thread solution. For example, the analysis system 102 may receive a request to execute a process flow, method, or algorithm relating to generating a design, implementation plan, or set of outputs associated with a knowledge-based digital thread solution. In this case, the analysis system 102 may use a systematic framework to perform root cause analysis and process transformation, use a step-by-step process to assess and measure a digital thread maturity, aggregate a set of maturity values across a set of dimensions, and synthesize a set of assessment results (including a transformation complexity metric) to generate an output, as described in more detail herein.

Additionally, or alternatively, the analysis system 102 may receive a request to generate an identification and determine a utilization of anti-patterns for digital thread maturity. For example, the analysis system 102 may receive a request to use clustering techniques to analyze factors and synthesize a set of anti-patterns of digital thread maturity. An anti-pattern of digital thread maturity may represent a set of root causes of low maturity for digital threads, from which the analysis system 102 can derive opposite characteristics for achieving high maturity digital threads. The anti-patterns may be characterized in terms of process, information, or system, among other examples, as described in more detail herein. In this case, the analysis system 102 may be triggered to generate a maturity assessment, determine complexity of a digital thread maturity process, and generate a set of design or development outputs.

In some implementations, the analysis system 102 receives a request to analyze a set of assessment results, design options, or resource allocations associated with a knowledge-based digital thread solution. For example, based on a completion of a digital thread maturity assessment, as described herein, the analysis system 102 may determine a transformation complexity, root cause, or anti-pattern, and may analyze a set of results to determine an allocation of technical tasks to address capability issues or gaps, as described in more details herein. Additionally, or alternatively, the analysis system 102 may generate a strategy rationalization associated with a risk-reward calculation for digital thread transformation. For example, the analysis system 102 may receive a request to generate a synthesis or rationalization of a digital thread transformation implementation strategy in connection with a cost-benefit to an entity implementing the digital thread transformation implementation strategy.

As further shown in FIG. 1A, and by reference number 152, the analysis system 102 requests and receives workflow information. For example, the analysis system 102 may communicate with the data source 106 to obtain additional information regarding the strategy framework for the enterprise entity. In some implementations, the analysis system 102 requests information relating to the enterprise entity. For example, the analysis system 102 may request and receive information relating to a set of products, processes, systems, tools, or resources. Additionally, or alternatively, the analysis system 102 may request and receive information relating to a set of other enterprise entities. For example, the analysis system 102 may aggregate information relating to a plurality of entities to generate one or more artificial intelligence models, neural network models, machine learning models, or large language models associated with generating one or more outputs for digital thread transformation.

As shown in FIG. 1B, and by reference number 156, the analysis system 102 generates a root-cause analysis and a set of recommendations. For example, the analysis system 102 may model and characterize a current workflow, information state, or systems or tools relating to a strategy framework for an enterprise entity. In this case, based on generating the root-cause analysis, the analysis system 102 may define and validate a digital transformation (DTx) target relating to a digital thread process, information state, or system or tools for a strategy framework for an enterprise entity.

In some implementations, to generate the root cause analysis, the analysis system 102 executes one or more decision trees. For example, as shown, the analysis system 102 may generate a decision tree with a set of root causes C1 through CN associated with a set of root cause actions C1-A through CN-A. In this case, the analysis system 102 may establish the decision tree with a set of linkages between different root causes, and the analysis system 102 may traverse the decision tree to determine a set of root causes and root cause actions. As an example, a root cause may include a digital thread having missing, inadequate, or non-model-based information in a process, system, or tool, which results in a degraded (e.g., lower maturity) digital thread. In this example, a digital thread action may include augmenting the missing information with digital, model-based objects and linkages. As another example, a root cause may include a data inconsistency in a digital thread, which may correspond to a root cause action of identifying the data inconsistency across a set of data sources and generating a process or tool (e.g., program code) to eliminate the data inconsistency and ensure consistent data in the data source. As another example, the analysis system 102 may identify a root cause of a disconnection between a set of tools and may determine a root cause action of generating a tool to connect the set of tools, such as program code or an application programming interface to connect the set of tools.

In some implementations, the analysis system 102 generates or executes one or more algorithms relating to a root cause action. For example, for a root cause action of augmenting missing information with digital model-based objects and linkages, the analysis system 102 may execute an algorithm that includes process steps of identifying a design pattern, measuring or computing a degradation of a digital thread with respect to a plurality of dimensions (e.g., a process dimension, an information dimension, or a system/tool dimension, as described in more detail herein), estimate a complexity in achieving a digital thread transformation to a configured digital thread maturity outcome, and generating an output, as described in more detail herein.

As shown in FIG. 1C, and by reference number 158, the analysis system 102 generates a transformation complexity measurement. For example, the analysis system 102 may analyze a digital thread to characterize the digital thread with respect to a process transformation complexity, an information transformation complexity, or a system or tools transformation complexity, and may combine the complexity measurements in multiple dimensions into a single transformation complexity measurement vector. In some implementations, the analysis system 102 generates a transformation complexity measurement across multiple dimensions. For example, the analysis system 102 may generate a process transformation complexity measurement along a first dimension, a system and tool complexity measurement across a second dimension, and an information transformation complexity measurement across a third dimension. In this case, the analysis system 102 may use a vector addition determination to generate a total complexity measurement across the three dimensions. Additionally, or alternatively, the analysis system 102 may combine other quantities of dimensions of other complexity measurements to generate a total complexity measurement. In some implementations, the analysis system 102 categorizes the total complexity measurement according to a threshold. For example, the analysis system 102 may categorize a first range of total complexity measurements as low complexity, a second range of total complexity measurements as medium complexity, and a third range of total complexity measurements as high complexity. In this case, based on assigning the total complexity measurement to a category, the analysis system 102 may generate a resource allocation strategy, as described in more detail herein, that corresponds to the category. In other words, a low complexity digital thread transformation may be associated with a first type of resource allocation strategy and a high complexity digital thread transformation may be associated with a second type of resource allocation strategy.

As shown in FIG. 1D, and by reference number 160, the analysis system 102 identifies one or more discontinuities relating to a digital thread and an associated digital thread transformation. For example, the analysis system 102 may identify one or more process discontinuities, information discontinuities, or systems discontinuities, among other examples. In some implementations, the analysis system 102 determines one or more anti-patterns relating to digital thread maturity. As described above, an anti-pattern may relate to a determined set of factors that correlate with a low maturity digital thread. In this case, the analysis system 102 may use a machine learning model training procedure to determine a set of features of a machine learning model for categorizing a digital thread maturity level. In this case, the features may represent factors with a highest level of predictive value in predicting a low maturity level for a digital thread. Anti-patterns may be categorized according to processes, information, and systems. For example, process anti-patterns may represent factors that contribute to a discontinuity, a presence of manual operation, or non-value-added steps in a process. Information anti-patterns may represent factors that contribute to gaps or discontinuities in information objects or information linkages. System anti-patterns may represent factors that contribute to gaps or discontinuities in functionality, interoperability, or connectivity.

In some implementations, the analysis system 102 identifies a discontinuity or gap. For example, the analysis system 102 may determine an information element (IE1) is an input to a process step (PA) and is non-model-based (e.g., IE1 is a text-based, file-based document format, such as a .pdf file that is not machine understandable and is manually opened, read, and analyzed by a user of a client device). Accordingly, the analysis system 102 may identify a process discontinuity relating to the manual manipulation of the IE1. Further, when a result of the process step PA is a set of information element outputs IE2, IE3, and IE4 to a process step PB, and the process step PB has a feedback information element IE5 to the process step PA, the analysis system 102 may identify a discontinuity relating to an upstream process step PB providing information before a downstream process step PA can be completed. Additionally, or alternatively, when IE2, IE3, and IE4 are discrete information elements that are not packaged together, a lack of relational information between the information elements may be a process discontinuity. Additionally, or alternatively, the analysis system 102 may identify another information element IE6 that is an input to process step PB, that is non-authoritative (e.g., not from a data source that has a certification for data accuracy), which the analysis system 102 may classify as a process discontinuity. Additionally, or alternatively, the analysis system 102 may identify an information discontinuity relating to a missing link between information objects across different systems or tools. Additionally, or alternatively, the analysis system 102 may identify a system discontinuity relating to a lack of integration of one or more systems of a process, such as a system or tool being a siloed system or tool that does not integrate with other systems, among other examples.

As shown in FIG. 1E, and by reference number 162, the analysis system 102 allocates resources. For example, the analysis system 102 may use the complexity measurement and the identified discontinuities to generate an allocation strategy of resources for digital thread transformation. In some implementations, the analysis system 102 generates a set of recommendations associated with allocating resources. For example, based on identifying discontinuities, the analysis system 102 may determine a recommendation for allocating one or more resources to resolve the discontinuities. In this case, the analysis system 102 may allocate resources relating to a set of internal systems or external systems. Additionally, or alternatively, based on identifying the total complexity measurement, the analysis system 102 may allocate resources. For example, the analysis system 102 may allocate resources in accordance with a tier of complexity for a digital thread transformation. In other words, as shown, for a first level of total complexity, the analysis system 102 may allocate resources in a first manner and for a second level of total complexity the analysis system 102 may allocate resources in a second manner. Additionally, or alternatively, the analysis system 102 may have a multi-tier resource allocation decision tree for allocating resources. For example, the analysis system 102 may determine a first categorization of the total complexity measurement and may determine a second categorization of each component complexity measurement to determine how to allocate resources (e.g., between internal or external systems).

In some implementations, the analysis system 102 generates a business transformation implementation strategy. For example, the analysis system 102 may use information identifying the total complexity measurement (or a component thereof) and/or one or more discontinuities to select from a set of strategies for digital thread transformation, such as an all-at-once strategy, an incremental strategy, a lifecycle stage strategy, or a make-or-buy strategy. In this case, the analysis system 102 may use a machine learning model or decision tree to select from the different strategy options, and may generate a resource allocation in accordance with the selected strategy. In some implementations, the analysis system 102 generates a complexity-value visualization or metric. For example, the analysis system 102 may determine a total complexity measurement decomposed by lifecycle stages (e.g., lifecycle value stream stages) into a heat-map, determine a value metric for transforming each stage of the lifecycle (e.g., each stage of a lifecycle value stream) with a digital thread, and assess characteristics with respect to complexity, benefit, and cost to determine a resource allocation. In some implementations, the analysis system 102 generates a user interface for displaying one or more metrics, heat-maps, or determinations.

As shown in FIG. 1F, and by reference number 164, the analysis system 102 transmits a set of outputs. For example, the analysis system 102 may transmit, to the client device 104 and to fulfill the request from the client device 104, information identifying a set of task assignments relating to the allocation strategy of resources for digital thread transformation. In some implementations, the analysis system 102 transmits an output identifying an assignment of a set of tasks. For example, the analysis system 102 may assign different digital thread transformation tasks to different client devices 104 for completion. Additionally, or alternatively, the analysis system 102 may transmit outputs associated with scheduling meetings to discuss results of an analysis (or discuss a set of generated recommendations) with a set of stakeholders. Additionally, or alternatively, the analysis system 102 may transmit outputs associated with tracking one or more parts or information elements. Additionally, or alternatively, the analysis system 102 may transmit outputs associated with executing one or more systems or tools to perform one or more tasks relating to digital thread transformation. In some implementations, the analysis system 102 transmits one or more outputs associated with providing, for display via a client device 104, a user interface identifying a result of one or more analyses performed by the analysis system 102 in connection with analyzing a digital thread transformation.

As further shown in FIG. 1F, and by reference numbers 166 and 168, the analysis system 102 may receive tracking information and may log the tracking information with a data source 106. For example, the analysis system 102 may receive tracking information from the client device 104 relating to the resource allocation strategy and may log the tracking information with the data source 106 to enable traceability of the digital thread transformation. In some implementations, the tracking information relates to traceability. For example, the analysis system 102 may receive traceability information relating to a set of lifecycle stages associated with a digital thread transformation. In some implementations, the analysis system 102 assigns unique identifiers to facilitate traceability information. For example, the analysis system 102 may automatically assign a unique identifier to a particular part and may use the tracking information, in connection with one or more digital threads, to track a lifecycle of the part.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 includes an analysis system 201, which may include one or more elements of and/or may execute within a cloud computing system 202. The cloud computing system 202 may include one or more elements 203-212, as described in more detail below. As further shown in FIG. 2, environment 200 may include a network 220, a target system 230, a client device 240, and/or a data source device 250. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the analysis system 201 may include one or more elements 203-212 of the cloud computing system 202, may execute within the cloud computing system 202, and/or may be hosted within the cloud computing system 202, in some implementations, the analysis system 201 may not be cloud-based (e.g., may be implemented outside of a cloud computing system) or may be partially cloud-based. For example, the analysis system 201 may include one or more devices that are not part of the cloud computing system 202, such as device 300 of FIG. 3, which may include a standalone server or another type of computing device. The analysis system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The target system 230 may include one or more devices capable of receiving, generating, storing, processing, providing, and/or routing information associated with a digital transformation, as described elsewhere herein. The target system 230 may include a communication device and/or a computing device. For example, the target system 230 may include a server, such as an application server, a client server, a web server, a database server, a host server, a proxy server, a virtual server (e.g., executing on computing hardware), or a server in a cloud computing system. In some implementations, the target system 230 may include computing hardware used in a cloud computing environment, such as one or more serverless components (e.g., one or more serverless functions), among other examples.

The client device 240 may include one or more devices capable of receiving, generating, storing, processing, and/or providing information associated with a digital transformation implementation strategy, as described elsewhere herein. The client device 240 may include a communication device and/or a computing device. For example, the client device 240 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data source device 250 may include one or more devices capable of receiving, generating, storing, processing, and/or providing information associated with a digital transformation, as described elsewhere herein. The data source device 250 may include a communication device and/or a computing device. For example, the data source device 250 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the data source device 250 may store data relating to one or more digital threads, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with a dynamic strategy framework and an end-to-end digital thread orchestrator for enterprise digital transformations. The device 300 corresponds to one or more of an analysis system 201, a target system 230, a client device 240, and/or a data source device 250. In some implementations, the analysis system 201, the target system 230, the client device 240, and/or the data source device 250 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

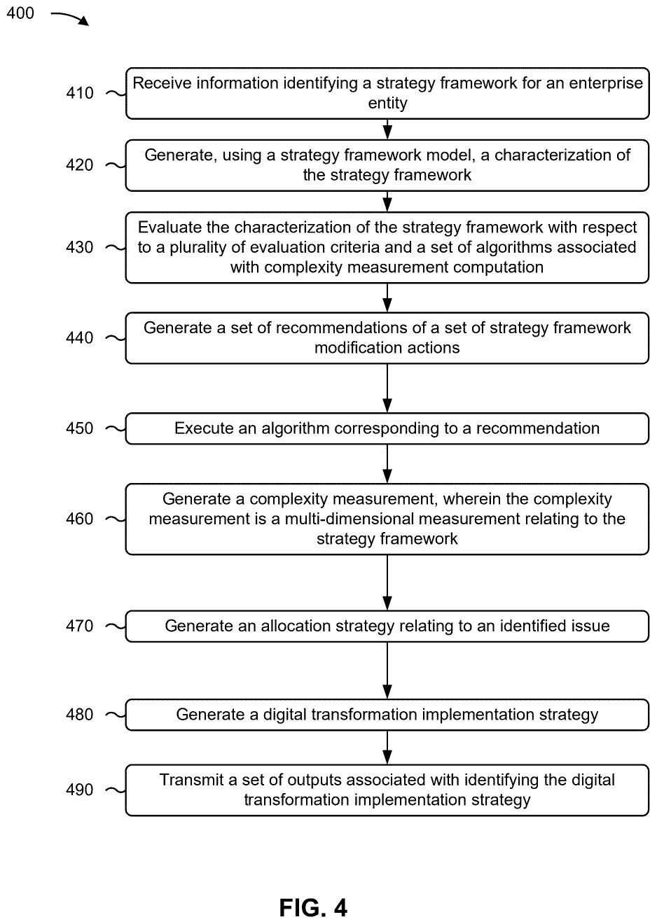

FIG. 4 is a flowchart of an example process 400 associated with a dynamic strategy framework to derive transformation strategies based on identified discontinuities, gaps, issues, or root causes. One or more process blocks of FIG. 4 are performed by a device (e.g., analysis system 201) and/or by another device or a group of devices separate from or including the device, such as a target system (e.g., the target system 230), a client device (e.g., the client device 240), and/or a data source (e.g., the data source device 250). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving information identifying a strategy framework for an enterprise entity (block 410). For example, the device may receive information identifying a strategy framework for an enterprise entity, as described above. In some aspects, the strategy framework includes a set of information transformations.

As further shown in FIG. 4, process 400 includes generating, using a strategy framework model, a characterization of the strategy framework (block 420). For example, the device may generate, using a strategy framework model, a characterization of the strategy framework, as described above.

As further shown in FIG. 4, process 400 includes evaluating the characterization of the strategy framework with respect to a plurality of evaluation criteria and a set of algorithms associated with complexity measurement computation (block 430). For example, the device may evaluate the characterization of the strategy framework with respect to a plurality of evaluation criteria and a set of algorithms associated with complexity measurement computation, as described above.

As further shown in FIG. 4, process 400 includes generating a set of recommendations of a set of strategy framework modification actions (block 440). For example, the device may generate, based on the plurality of evaluation criteria and the complexity measurement computation, a set of recommendations of a set of strategy framework modification actions, as described above.

As further shown in FIG. 4, process 400 includes executing an algorithm corresponding to the recommendation (block 450). For example, the device may execute, to implement a recommendation of the set of recommendations, an algorithm corresponding to the recommendation, as described above.

As further shown in FIG. 4, process 400 includes generating a complexity measurement, wherein the complexity measurement is a multi-dimensional measurement relating to the strategy framework (block 460). For example, the device may generate, based on executing the algorithm, a complexity measurement, wherein the complexity measurement is a multi-dimensional measurement relating to the strategy framework, as described above.

As further shown in FIG. 4, process 400 includes generating an allocation strategy relating to an identified issue (block 470). For example, the device may generate, based on the complexity measurement, an allocation strategy relating to an identified issue, wherein the allocation strategy includes an identification of a system to remediate the identified issue, and wherein the system is a new system or a supplementary system, as described above.

As further shown in FIG. 4, process 400 includes generating a digital transformation implementation strategy (block 480). For example, the device may generate, based on the allocation strategy, a digital transformation implementation strategy, as described above.

As further shown in FIG. 4, process 400 includes transmitting a set of outputs associated with identifying the digital transformation implementation strategy (block 490). For example, the device may transmit a set of outputs associated with identifying the digital transformation implementation strategy or one or more determinations from which the digital transformation implementation strategy is generated, as described above.

Process 400 may include additional aspects, such as any single aspect or any combination of aspects described below and/or in connection with one or more other processes described elsewhere herein.

In a first aspect, evaluating the characterization of the strategy framework comprises identifying one or more process discontinuities with respect to the strategy framework, and wherein generating the complexity measurement comprises generating the complexity measurement based on the one or more process discontinuities.

In a second aspect, alone or in combination with the first aspect, evaluating the characterization of the strategy framework comprises identifying one or more information gaps associated with one or more steps of the strategy framework, and wherein generating the complexity measurement comprises generating the complexity measurement based on the one or more information gaps.

In a third aspect, alone or in combination with one or more of the first and second aspects, evaluating the characterization of the strategy framework comprises identifying a system issue with one or more systems or applications being executed in connection with the strategy framework, and wherein generating the complexity measurement comprises generating the complexity measurement based on the system issue.

In a fourth aspect, alone or in combination with one or more of the first through third aspects, process 400 includes generating a root cause analysis for the strategy framework based on evaluating the characterization of the strategy framework, and wherein generating the set of recommendations comprises generating the set of recommendations based on the root cause analysis.

In a fifth aspect, alone or in combination with one or more of the first through fourth aspects, the set of recommendations includes a particular recommendation selected from one of a plurality of recommendation categories, wherein the plurality of recommendation categories are associated with different digital transformation scopes of work.

In a sixth aspect, alone or in combination with one or more of the first through fifth aspects, process 400 includes receiving information identifying a progress associated with a transformation of a component associated with the strategy framework from a resource associated with the digital transformation implementation strategy, and updating a tracking system data structure with the information identifying the progress.

In a seventh aspect, alone or in combination with one or more of the first through sixth aspects, process 400 includes assigning, to each component of a system, a unique identifier, and wherein receiving the information identifying the progress comprises identifying the component using the unique identifier.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

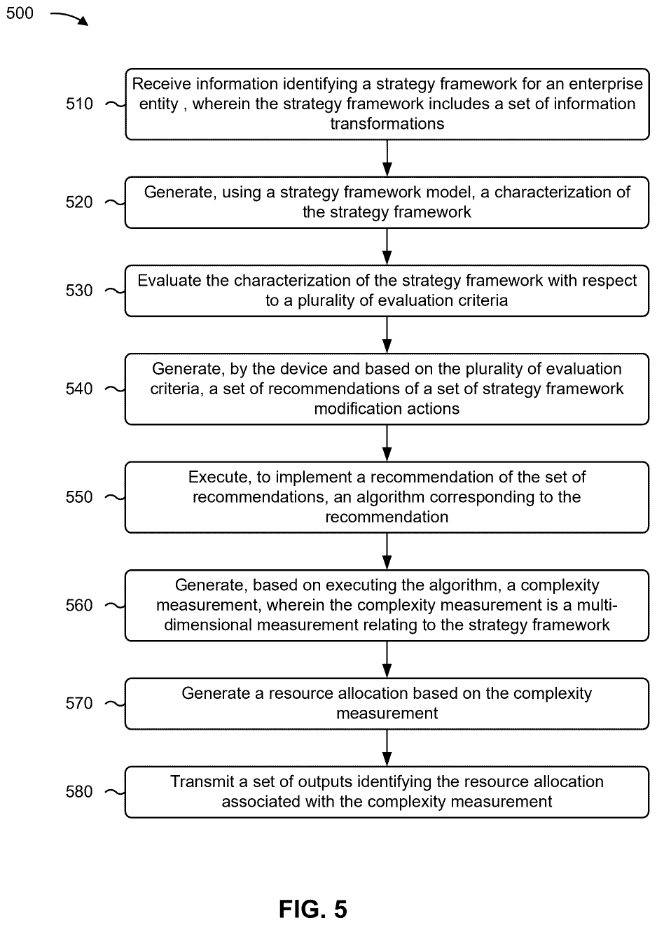

FIG. 5 is a flowchart of an example process 500 associated with a dynamic strategy framework to derive resource allocation strategies optimized to a strategic or targeted transformation strategy. One or more process blocks of FIG. 5 are performed by a device (e.g., analysis system 201) and/or by another device or a group of devices separate from or including the device, such as a target system (e.g., the target system 230), a client device (e.g., the client device 240), and/or a data source (e.g., the data source device 250). Additionally, or alternatively, one or more process blocks of FIG. 5 may be performed by one or more components of device 300, such as processor 320, memory 330, input component 340, output component 350, and/or communication component 360.

As shown in FIG. 5, process 500 includes receiving information identifying a strategy framework for an enterprise entity, wherein the strategy framework includes a set of information transformations (block 510). For example, the device may receive information identifying a strategy framework for an enterprise entity, wherein the strategy framework includes a set of information transformations, as described above. In some aspects, the strategy framework includes a set of information transformations.

As further shown in FIG. 5, process 500 includes generating, using a strategy framework model, a characterization of the strategy framework (block 520). For example, the device may generate, using a strategy framework model, a characterization of the strategy framework, as described above.

As further shown in FIG. 5, process 500 includes evaluating the characterization of the strategy framework with respect to a plurality of evaluation criteria (block 530). For example, the device may evaluate the characterization of the strategy framework with respect to a plurality of evaluation criteria, as described above.

As further shown in FIG. 5, process 500 includes generating, based on the plurality of evaluation criteria, a set of recommendations of a set of strategy framework modification actions (block 540). For example, the device may generate, based on the plurality of evaluation criteria, a set of recommendations of a set of strategy framework modification actions, as described above.

As further shown in FIG. 5, process 500 includes executing, to implement a recommendation of the set of recommendations, an algorithm corresponding to the recommendation (block 550). For example, the device may execute, to implement a recommendation of the set of recommendations, an algorithm corresponding to the recommendation, as described above.

As further shown in FIG. 5, process 500 includes generating, based on executing the algorithm, a complexity measurement, wherein the complexity measurement is a multi-dimensional measurement relating to the strategy framework (block 560). For example, the device may generate, based on executing the algorithm, a complexity measurement, wherein the complexity measurement is a multi-dimensional measurement relating to the strategy framework, as described above.

As further shown in FIG. 5, process 500 includes generating a resource allocation based on the complexity measurement (block 570). For example, the device may generate a resource allocation based on the complexity measurement, as described above.

As further shown in FIG. 5, process 500 includes transmitting a set of outputs identifying the resource allocation associated with the complexity measurement (block 580). For example, the device may transmit a set of outputs identifying the resource allocation associated with the complexity measurement, as described above.

Process 500 may include additional aspects, such as any single aspect or any combination of aspects described below and/or in connection with one or more other processes described elsewhere herein.

In a first aspect, process 500 includes generating the resource allocation using a resource allocation model.

In a second aspect, alone or in combination with the first aspect, process 500 includes determining a cost-value analysis for a set of transformations of a set of steps of the strategy framework, and generating the resource allocation based on the cost-value analysis.

In a third aspect, alone or in combination with one or more of the first and second aspects, the resource allocation includes a first allocation of a set of tasks to a first set of source systems and a second allocation of a second set of tasks to a set of external systems.

In a fourth aspect, alone or in combination with one or more of the first through third aspects, a division of the resource allocation into the first allocation and the second allocation is based on the complexity measurement.

In a fifth aspect, alone or in combination with one or more of the first through fourth aspects, the complexity measurement includes a multi-dimensional part relating to a first threshold determination for the division of the resource allocation and includes a set of single-dimensional parts relating to a set of second threshold determinations for the division of the resource allocation.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

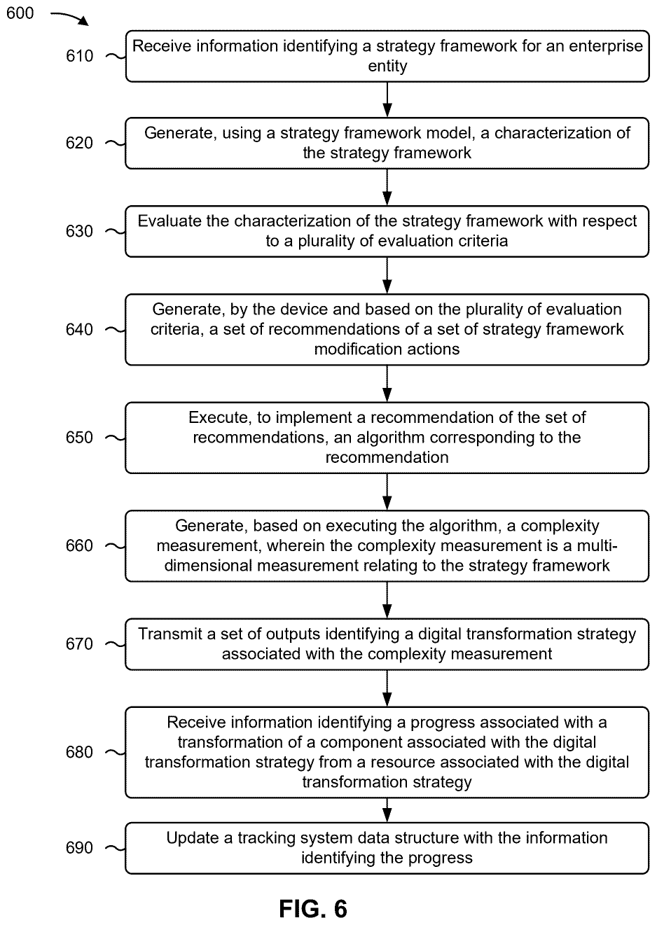

FIG. 6 is a flowchart of an example process 600 associated with a dynamic strategy framework to derive a transformation implementation strategy and track a progress of an implementation. One or more process blocks of FIG. 6 are performed by a device (e.g., analysis system 201) and/or by another device or a group of devices separate from or including the device, such as a target system (e.g., the target system 230), a client device (e.g., the client device 240), and/or a data source (e.g., the data source device 250). Additionally, or alternatively, one or more process blocks of FIG. 6 may be performed by one or more components of device 300, such as processor 320, memory 330, input component 340, output component 350, and/or communication component 360.

As shown in FIG. 6, process 600 includes receiving information identifying a strategy framework for an enterprise entity, wherein the strategy framework includes a set of information transformations (block 610). For example, the device may receive information identifying a strategy framework for an enterprise entity, wherein the strategy framework includes a set of information transformations, as described above. In some aspects, the strategy framework includes a set of information transformations.

As further shown in FIG. 6, process 600 includes generating, using a strategy framework model, a characterization of the strategy framework (block 620). For example, the device may generate, using a strategy framework model, a characterization of the strategy framework, as described above.

As further shown in FIG. 6, process 600 includes evaluating the characterization of the strategy framework with respect to a plurality of evaluation criteria (block 630). For example, the device may evaluate the characterization of the strategy framework with respect to a plurality of evaluation criteria, as described above.

As further shown in FIG. 6, process 600 includes generating, based on the plurality of evaluation criteria, a set of recommendations of a set of strategy framework modification actions (block 640). For example, the device may generate, based on the plurality of evaluation criteria, a set of recommendations of a set of strategy framework modification actions, as described above.

As further shown in FIG. 6, process 600 includes executing, to implement a recommendation of the set of recommendations, an algorithm corresponding to the recommendation (block 650). For example, the device may execute, to implement a recommendation of the set of recommendations, an algorithm corresponding to the recommendation, as described above.

As further shown in FIG. 6, process 600 includes generating, based on executing the algorithm, a complexity measurement, wherein the complexity measurement is a multi-dimensional measurement relating to the strategy framework (block 660). For example, the device may generate, based on executing the algorithm, a complexity measurement, wherein the complexity measurement is a multi-dimensional measurement relating to the strategy framework, as described above.

As further shown in FIG. 6, process 600 includes transmitting a set of outputs identifying a digital transformation implementation strategy associated with the complexity measurement (block 670). For example, the device may transmit a set of outputs identifying a digital transformation implementation strategy associated with the complexity measurement, as described above.

As further shown in FIG. 6, process 600 includes receiving information identifying a progress associated with a transformation of a component associated with the digital transformation implementation strategy from a resource associated with the digital transformation implementation strategy (block 680). For example, the device may receive information identifying a progress associated with a transformation of a component associated with the digital transformation implementation strategy from a resource associated with the digital transformation implementation strategy, as described above.

As further shown in FIG. 6, process 600 includes updating a tracking system data structure with the information identifying the progress (block 690). For example, the device may update a tracking system data structure with the information identifying the progress, as described above.

Process 600 may include additional aspects, such as any single aspect or any combination of aspects described below and/or in connection with one or more other processes described elsewhere herein.

In a first aspect, the set of recommendations includes a particular recommendation selected from one of a plurality of recommendation categories, wherein the plurality of recommendation categories are associated with different digital transformation scopes of work.

In a second aspect, alone or in combination with the first aspect, process 600 includes assigning, to each component of a system, a unique identifier, and wherein the one or more instructions, that cause the device to receive the information identifying the progress, cause the device to identifying the component using the unique identifier.

In a third aspect, alone or in combination with one or more of the first and second aspects, process 600 includes identifying a system issue with one or more systems or applications being executed in connection with the strategy framework, and wherein the one or more instructions, that cause the device to generate the complexity measurement, cause the device to generating the complexity measurement based on the system issue.

In a fourth aspect, alone or in combination with one or more of the first through third aspects, process 600 includes generating a root cause analysis for the strategy framework based on evaluating the characterization of the strategy framework, and wherein the one or more instructions, that cause the device to generate the set of recommendations, cause the device to generating the set of recommendations based on the root cause analysis.

In a fifth aspect, alone or in combination with one or more of the first through fourth aspects, process 600 includes generating the digital transformation implementation strategy based on the complexity measurement.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations described herein to the precise forms that are described. Modifications and variations can be made in light of the above description or may be acquired from practice of the implementations described herein.

As used herein, the term “component” is intended to be broadly construed as hardware, firmware, and/or a combination of hardware and software. It will be apparent that systems and/or methods described herein can be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in the specification, these combinations are not intended to limit the implementations described herein. In fact, many of these features can be combined in ways not specifically recited in the claims and/or described in the specification. For example, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and can be used interchangeably with “one or more.” Further, as used herein, the article “the” is intended to include one or more items referenced in connection with the article “the” and can be used interchangeably with “the one or more.” Furthermore, as used herein, the term “set” is intended to include one or more items (e.g., related items, unrelated items, or a combination of related and unrelated items,), and can be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and can be used interchangeably with “and/or,” unless explicitly stated otherwise (e.g., if used in combination with “either” or “only one of”).

What is claimed is:

1. A method, comprising:
receiving, by a device, information identifying a strategy framework for an enterprise entity,
wherein the strategy framework includes a set of information transformations;
generating, by the device and using a strategy framework model, a characterization of the strategy framework;
evaluating, by the device, the characterization of the strategy framework with respect to a plurality of evaluation criteria and a set of algorithms associated with complexity measurement computation;
generating, by the device and based on the plurality of evaluation criteria and the complexity measurement computation, a set of recommendations of a set of strategy framework modification actions;
executing, by the device and to implement a recommendation of the set of recommendations, an algorithm corresponding to the recommendation;
generating, based on executing the algorithm, a complexity measurement, wherein the complexity measurement is a multi-dimensional measurement relating to the strategy framework;
generating, by the device and based on the complexity measurement, an allocation strategy relating to an identified issue, wherein the allocation strategy includes an identification of a system to remediate the identified issue, wherein the system is a new system or a supplementary system;
generating, by the device and based on the allocation strategy, a digital transformation implementation strategy; and
transmitting, by the device, a set of outputs associated with identifying the digital transformation implementation strategy or one or more determinations from which the digital transformation implementation strategy is generated.

2. The method of claim 1, wherein evaluating the characterization of the strategy framework comprises:
identifying one or more process discontinuities with respect to the strategy framework; and
wherein generating the complexity measurement comprises:
generating the complexity measurement based on the one or more process discontinuities.

3. The method of claim 1, wherein evaluating the characterization of the strategy framework comprises:
identifying one or more information gaps associated with one or more steps of the strategy framework; and
wherein generating the complexity measurement comprises:
generating the complexity measurement based on the one or more information gaps.

4. The method of claim 1, wherein evaluating the characterization of the strategy framework comprises:
identifying one or more system issues with one or more systems or applications being executed in connection with the strategy framework; and
wherein generating the complexity measurement comprises:
generating the complexity measurement based on the one or more system issues.

5. The method of claim 1, further comprising:
generating a root cause analysis for the strategy framework based on evaluating the characterization of the strategy framework; and
wherein generating the set of recommendations comprises:
generating the set of recommendations based on the root cause analysis.

6. The method of claim 1, wherein the set of recommendations includes a particular recommendation selected from one of a plurality of recommendation categories, wherein the plurality of recommendation categories are associated with different digital transformation scopes of work.

7. The method of claim 1, further comprising:
receiving information identifying a progress associated with a transformation of a component associated with the strategy framework from a resource associated with the digital transformation implementation strategy; and
updating a tracking system data structure with the information identifying the progress.

8. The method of claim 7, further comprising:
assigning, to each component of a system, a unique identifier; and
wherein receiving the information identifying the progress comprises:
identifying the component using the unique identifier.

9. A device, comprising:
one or more memories; and
one or more processors, coupled to the one or more memories, configured to:
receive information identifying a strategy framework for an enterprise entity,
wherein the strategy framework includes a set of information transformations;
generate, using a strategy framework model, a characterization of the strategy framework;
evaluate the characterization of the strategy framework with respect to a plurality of evaluation criteria;
generate, by the device and based on the plurality of evaluation criteria, a set of recommendations of a set of strategy framework modification actions;
execute, to implement a recommendation of the set of recommendations, an algorithm corresponding to the recommendation;
generate, based on executing the algorithm, a complexity measurement, wherein the complexity measurement is a multi-dimensional measurement relating to the strategy framework;
generate a resource allocation based on the complexity measurement; and
transmit a set of outputs identifying the resource allocation associated with the complexity measurement.

10. The device of claim 9, wherein the one or more processors, to generate the resource allocation, are configured to:
generate the resource allocation using a resource allocation model.

11. The device of claim 9, wherein the one or more processors, to generate the resource allocation, are configured to:
determine a cost-value analysis for a set of transformations of a set of steps of the strategy framework; and
generate the resource allocation based on the cost-value analysis.

12. The device of claim 9, wherein the resource allocation includes a first allocation of a set of tasks to a first set of source systems and a second allocation of a second set of tasks to a set of external systems.

13. The device of claim 12, wherein a division of the resource allocation into the first allocation and the second allocation is based on the complexity measurement.

14. The device of claim 13, wherein the complexity measurement includes a multi-dimensional part relating to a first threshold determination for the division of the resource allocation and includes a set of single-dimensional parts relating to a set of second threshold determinations for the division of the resource allocation.

15. A non-transitory computer-readable medium storing a set of instructions, the set of instructions comprising:
one or more instructions that, when executed by one or more processors of a device, cause the device to:
receive information identifying a strategy framework for an enterprise entity,
wherein the strategy framework includes a set of information transformations;
generate, using a strategy framework model, a characterization of the strategy framework;
evaluate the characterization of the strategy framework with respect to a plurality of evaluation criteria;
generate, by the device and based on the plurality of evaluation criteria, a set of recommendations of a set of strategy framework modification actions;
execute, to implement a recommendation of the set of recommendations, an algorithm corresponding to the recommendation;
generate, based on executing the algorithm, a complexity measurement, wherein the complexity measurement is a multi-dimensional measurement relating to the strategy framework;
transmit a set of outputs identifying a digital transformation implementation strategy associated with the complexity measurement;
receive information identifying a progress associated with a transformation of a component associated with the digital transformation implementation strategy from a resource associated with the digital transformation implementation strategy; and
update a tracking system data structure with the information identifying the progress.

16. The non-transitory computer-readable medium of claim 15, wherein the set of recommendations includes a particular recommendation selected from one of a plurality of recommendation categories, wherein the plurality of recommendation categories are associated with different digital transformation scopes of work.

17. The non-transitory computer-readable medium of claim 15, wherein the one or more instructions further cause the device to:
assign, to each component of a system, a unique identifier; and
wherein the one or more instructions, that cause the device to receive the information identifying the progress, cause the device to:
identify the component using the unique identifier.

18. The non-transitory computer-readable medium of claim 15, wherein the one or more instructions, that cause the device to evaluate the characterization of the strategy framework, cause the device to:
identify a system issue with one or more systems or applications being executed in connection with the strategy framework; and
wherein the one or more instructions, that cause the device to generate the complexity measurement, cause the device to:
generate the complexity measurement based on the system issue.

19. The non-transitory computer-readable medium of claim 15, wherein the one or more instructions further cause the device to:
generate a root cause analysis for the strategy framework based on evaluating the characterization of the strategy framework; and
wherein the one or more instructions, that cause the device to generate the set of recommendations, cause the device to:
generate the set of recommendations based on the root cause analysis.

20. The non-transitory computer-readable medium of claim 15, wherein the one or more instructions further cause the device to:
generate the digital transformation implementation strategy based on the complexity measurement.
